(19) United States
(12) Patent Application Publication
(10) Pub. No.: US 2012/0204411 A1
(43) Pub. Date: Aug. 16, 2012

(54) PRESSURE CRIMPER WITH ELLIPTICAL FACE

(75) Inventors: Juan F. Davila, Cypress, TX (US); Colin J. Lewis, Houston, TX (US)

(73) Assignee: TESCO CORPORATION, Houston, TX (US)

(21) Appl. No.: 13/025,037

(22) Filed: Feb. 10, 2011

(51) Int. Cl. B23P 11/00; B23Q 3/00

(52) U.S. Cl. 29/505; 29/283.5

(57) ABSTRACT

A pressure crimper for crimping a centralizer to a metal tubular. The crimper includes a generally cylindrical body having a central opening sufficiently large to allow insertion therethrough of a centralizer end having an external diameter; a sidewall of substantially uniform thickness including an inner-facing surface directed to the central opening and an outer-facing surface onto which are formed a plurality of passages. A piston is retained within each passage for hydraulic actuation inward. A face of each piston faces radially inward and has an elliptical shape. When the pistons are actuated, they apply pressure to the outer surface of the centralizer end to secure it to the tubular.

### FIELD OF THE INVENTION

The present invention relates in general to a casing centralizers, and in particular to an improved crimper for attaching a centralizer to casing.

### BACKGROUND OF THE INVENTION

The processes of drilling and completing well bores in earth materials using tubular strings are frequently benefited if the tubular string is prevented from fully eccentering and generally contacting or laying against the borehole wall. Devices, typically referred to as centralizers, are employed to provide this function of reducing eccentricity, or centralizing, the tubular string within the borehole. These devices are configured to economically meet a variety of drilling and completion applications.

As disclosed in Canadian patent application 2350681, filed Jun. 15, 2001 in the name of TESCO Corporation, the demands of drilling with casing lead to the need for inexpensive casing centralizers which are rugged, for example resistant to rib failure, comparatively easy to attach to the casing and able to withstand drilling rotation sufficient to complete at least one well.

When the tubular string is subjected to rotation forces, as in casing while drilling operations, the ends of a centralizer are typically crimped to the tubular. One crimping tool uses hydraulic pistons positioned around an end of the centralizer apply pressure to crimp the end to the tubular. Such tools are generally large, heavy, and difficult to repair. Further, the pressure applied by the crimping tool at times exceeds the recommended pressure rating of the tubular, causing a safety hazard.

A technique is desired to address the problems associated with current crimping tools.

### SUMMARY OF THE INVENTION

In an embodiment of the pressure crimper, the crimping tool comprises a body made from a suitably strong and rigid material having a central passageway to accommodate a tubular work piece such as a centralizer. The body has an external diameter; a sidewall of substantially uniform thickness including an inner-facing surface directed to the central opening, and an outer-facing surface. A plurality of passages are formed in the sidewall. A piston is retained within each passage for hydraulic actuation inward. A face of each piston faces radially inward and has an elliptical shape. When the pistons are actuated, they apply pressure to the outer surface of the centralizer end to secure it to the tubular. A passage may be formed within the body that communicates with each of the passages carrying the pistons. A hydraulic source connected to the passage formed in the body provides the hydraulic fluid to the passage in the body and distributes it to each piston passage to actuate the pistons.

### BRIEF DESCRIPTION OF THE DRAWINGS

A further, detailed, description of the invention, briefly described above, will follow by reference to the following drawings of specific embodiments of the invention. These drawings depict only typical embodiments of the invention and are therefore not to be considered limiting of its scope. In the drawings:

FIG. 1 is a plan view of a crimper according to the present invention;

FIG. 2 is a sectional view along 2-2 of the crimper shown in FIG. 1;

FIG. 3 is an enlarged partial sectional view of a piston assembly of the crimper shown in FIG. 1;

FIG. 4 is a perspective view of FIG. 1.

FIG. 5 is an enlarged perspective view of an elliptical face plate attached the piston in the crimper shown in FIG. 1.

### DETAILED DESCRIPTION

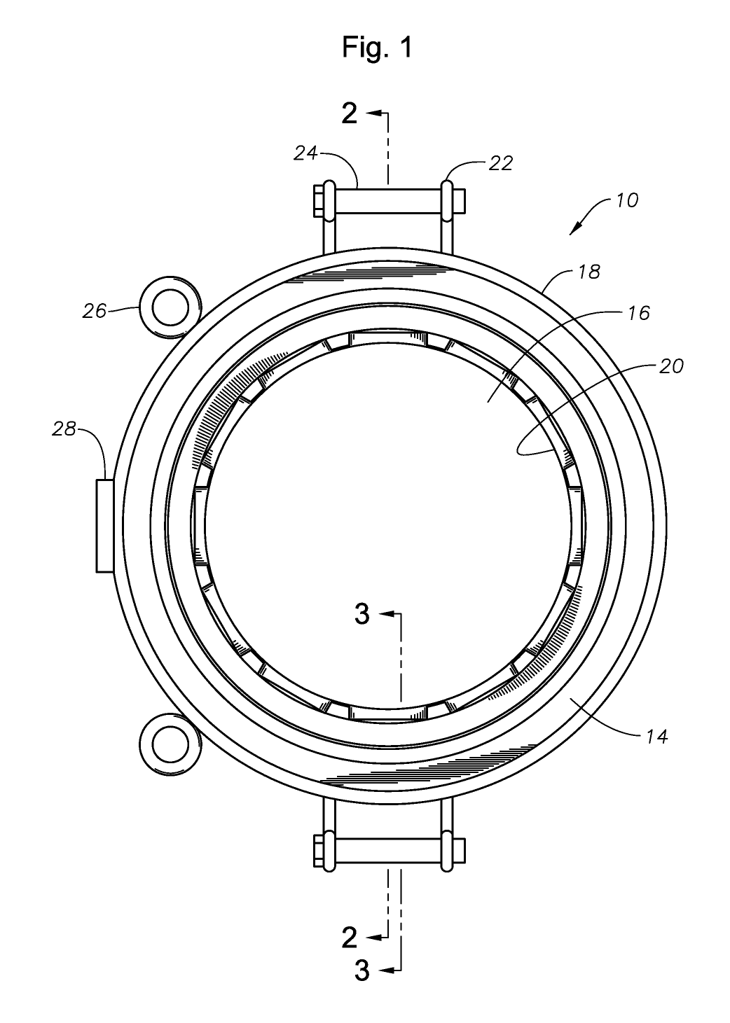

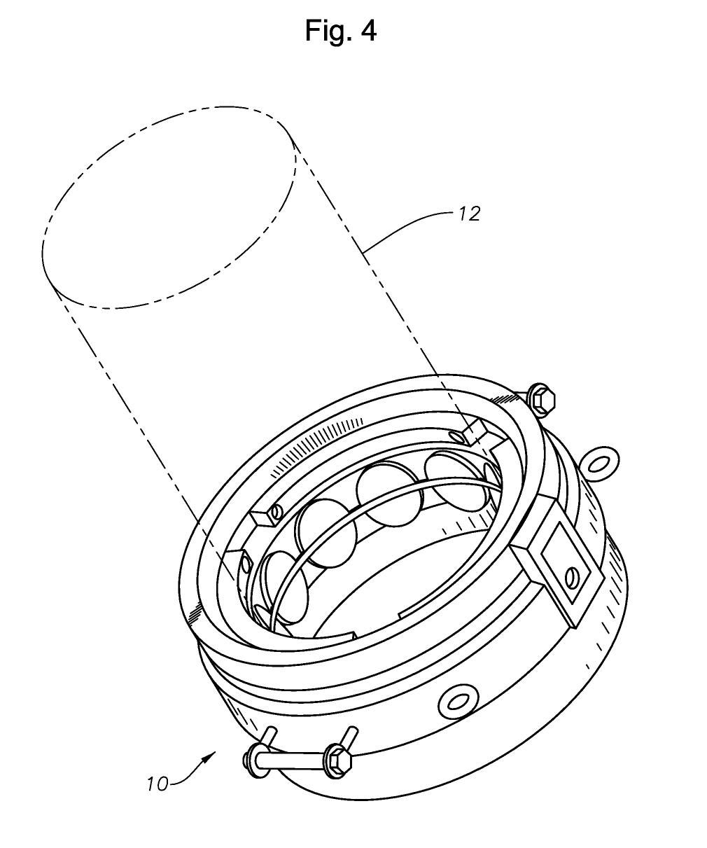

According to the present invention, a pressure crimper 10 is provided as shown in FIGS. 1 to 5, for placement on a centralizer 12 (FIG. 4).

Referring to FIG. 1, a plan view of an embodiment of the pressure crimper or crimping tool 10 is shown. The crimper 10 comprises a body 14 made from a suitably strong and rigid material having a central passageway 16 to accommodate a tubular work piece such as a centralizer 12 (FIG. 4). The body 14 has an external surface 18; a sidewall of substantially uniform thickness including an inner-facing surface 20 directed to the central opening 16. Eyebolts 22 may be secured to the external surface 18 and bolts 24 located and fastened to the eyebolts 22. The bolts 24 can provide an operator with means of handling the crimper. Additional eyebolts 26 may be secured onto the external surface 18 to allow the crimper 10 to be transported to the site of operation. A valve plate 28 may be bolted onto the external surface 18 and 42 to provide a safe platform for a three-way valve.

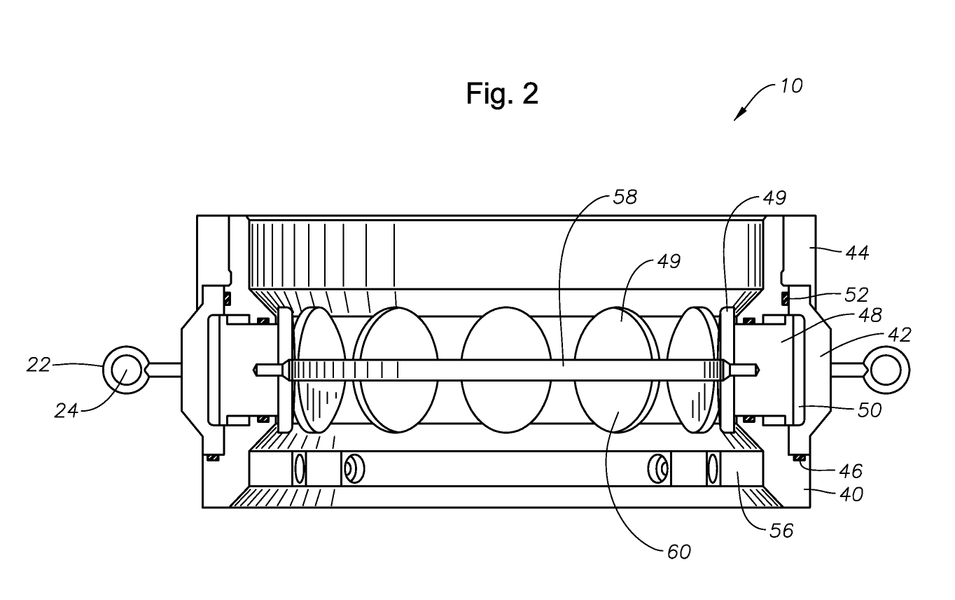

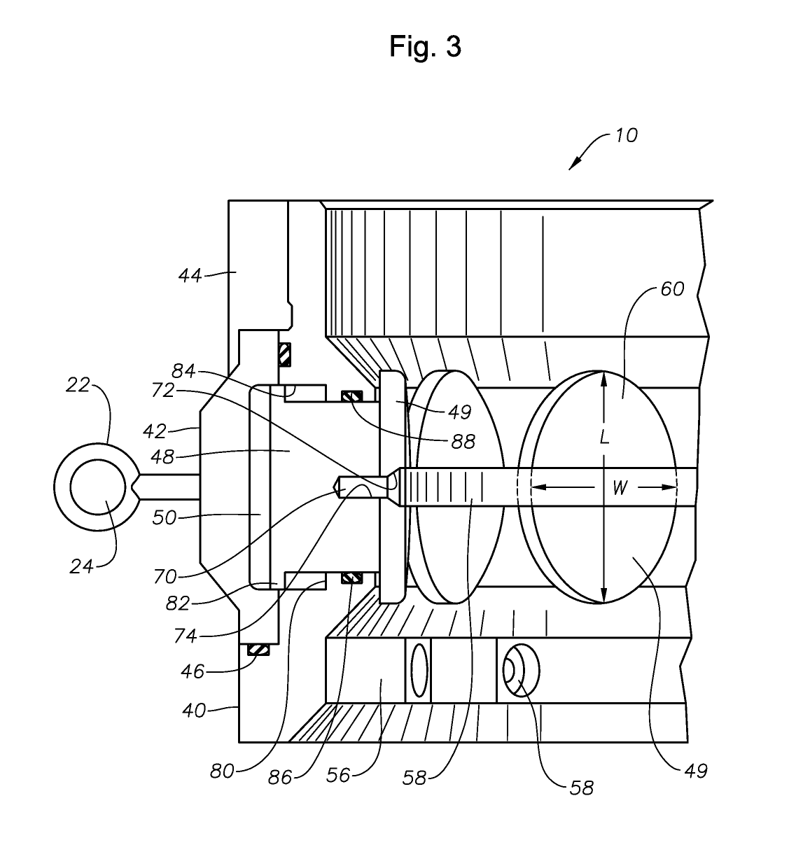

Referring to FIG. 2, a sectional view of an embodiment of the crimper 10 is illustrated. Further comprising the crimper 10 is a piston sub-assembly 40 joined to a pressure ring 42 by an assembly ring 44. The assembly ring 44 has an interior profile for maintaining the piston sub 40 joined with the pressure ring 42. An O-ring seal 46 is located between the piston sub 40 and the pressure ring 42. The piston sub 40 houses a piston 48 that may be actuated to an extended position when hydraulic fluid is introduced into a chamber 50 located behind the piston 48. The piston 48 is normally in a retracted position. An external source (not shown) provides the hydraulic fluid to the chamber 50. In this embodiment, a plurality of pistons 48 are disposed circumferentially in the body 14 of the crimper 10 and oriented radially inward. In this embodiment, the chamber 50 is common to a back surface of each piston 48 and the pistons 48 have a generally cylindrical shape. An elliptical face plate 49 is connected to an inward facing surface of the piston 48. An O-ring seal 52 may also be located between the pressure ring 42 and the piston sub 40 where the pressure ring 42 and piston sub 40 are joined by the assembly ring 44. The body 14 of the crimper 10 is stabilized by a stabilizer 56 that may be fastened to the inner facing surface 20 by bolts 58 that pass through passages in the stabilizer 56. The stabilizer 56 may comprise multiple pieces having a curvature corresponding to the inner surface 20 of the crimper 10. To align the elliptical plates 49, an alignment wire 58 may be placed in contact with an inner facing surface 60 of each plate 49. This allows for a uniform crimping of the centralizer 12 (FIG. 4). The piston sub 40, piston 48, and elliptical plate 49 are shown in more detail in FIG. 3 and will be described in a subsequent section.

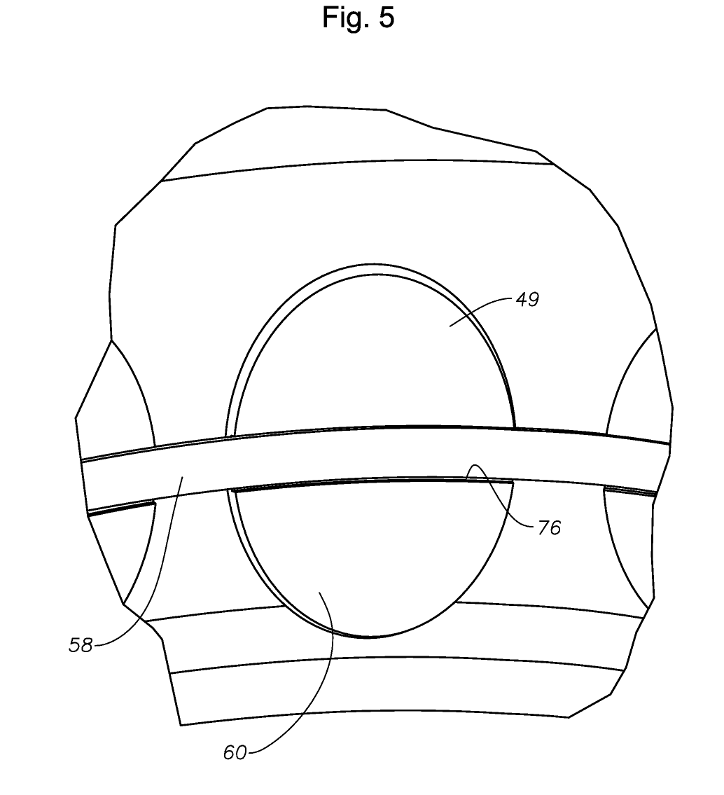

Referring to FIG. 3, an enlarged partial sectional view of an embodiment of the crimper 10 is shown. In this embodiment, the elliptical face plate 49 having a dimension L longer than a dimension W is fastened to the piston 48 via a fastener 70 that passes through a hole or passage 72 formed centrally on the plate 49 and a passage 74 formed in the piston 48. In this embodiment, a plurality of face plates 49 are fastened to a plurality of pistons 48 disposed circumferentially around the body 14. The face plates 49 form the inner facing surface 20 having a reduced inner diameter compared to an inner diameter of the piston sub 40. When installed, the alignment wire 58 is positioned over the fastener 70 of each of the elliptical face plates 49. A groove or recess 76 (FIG. 5) may be formed on the inner facing surface 60 of each elliptical face plate 49 to receive the alignment wire 58. In addition to allowing uniform crimping, the alignment wire 58 may function to return the pistons 48 to a retracted position once hydraulic fluid ceases to be forced into chamber 50.

Continuing to refer to FIG. 3 and referring to FIG. 5, the inner facing surface 60 of the elliptical face plate 49 is shown to curve radially inward. The curvature of each of the inner facing surface 60 of the elliptical face plate 49 facilitates engagement of a cylindrical exterior such as that of the centralizer 12 (FIG. 4). The curvature increases the surface area of the inward facing surface 60 of the elliptical face plate 49 that contacts the centralizer 12 without requiring an increase in the size of the piston 48 to thereby minimize the weight of the crimper 10.

During crimping operations, hydraulic fluid is injected into the common chamber 50 behind each piston 48 to force the piston into an extended position wherein the elliptical face plates 49 apply the required pressure to the outer surface of the centralizer 12 (FIG. 4) to crimp it to the tubular (not shown). The amount of radial inward movement of the piston 48 is limited by a cylindrical stop 80 formed in the piston sub 40 that interferes with a rim 82 formed at a back end of the piston 48. During pressurization, the piston 40 slides radially inward along a passage profile 84 having a diameter generally corresponding to that of the rim 82. To prevent leakage of the hydraulic fluid out into the elliptical face plate area, an O-ring 86 is located within a cylindrical groove 88 formed in the piston sub 40. The O-ring seals the piston sub 40 against the sliding piston 48. Once the crimping operation is complete, the hydraulic pressure can be released and the pistons 48 retracted. The alignment wire 58 or a separate spring may be used to retract the pistons 48. Alternatively, a spring (not shown) may be used around each of the pistons 48 to provide a retraction force to move the pistons 48 back to the normal position.

While the invention has been shown in only a few of its forms, it should be apparent to those skilled in the art that it is not so limited but is susceptible to various changes without departing from the scope of the invention.

1. An apparatus for securing a centralizer to a tubular comprising:
a body having a generally cylindrical shape and a central opening sufficiently large to allow insertion therethrough of a centralizer having an external diameter;
a sidewall of the body having an inner-facing surface directed to the central opening and an outer-facing surface;
a piston retained within a passage formed within the body, the piston having a radially, inward facing surface and slidingly moving from a retracted position to an extended position when hydraulic fluid is introduced into the body and in communication with the piston; and
a face plate connected to the inward facing surface of the piston, the face plate having an elliptical shape.

2. The apparatus of claim 1, further comprising a cylindrical chamber formed adjacent a back end of the piston to allow actuation of the piston to the extended position when hydraulic fluid is introduced into the chamber.

3. The apparatus of claim 1, wherein the piston is part of a plurality of pistons disposed circumferentially around the central opening of the body.

4. The apparatus of claim 3, wherein an alignment element engages the inward facing face of each face plate to align the pistons with each other.

5. The apparatus of claim 1, wherein the elliptical face plate is connected to the piston by a fastener that traverses a passage formed in the face plate and the piston.

6. The apparatus of claim 1, wherein the inward facing face of the face plate has a curvature that corresponds generally to the external diameter of the centralizer end, wherein the face plate applies radial pressure to the outer surface of the centralizer end when the piston is in the extended position.

7. The apparatus of claim 1, wherein an end of the centralizer is crimped to the tubular.

8. A crimping tool for securing a centralizer to a tubular comprising:
a body having a generally cylindrical shape and a central opening sufficiently large to allow insertion therethrough of a centralizer having an external diameter;
a sidewall of the body having an inner-facing surface directed to the central opening and an outer-facing surface;
a plurality of pistons retained within a plurality of passages formed within the body, the pistons having a radially, inward facing surface and a back end, and slidingly moving from a retracted position to an extended position when hydraulic fluid is introduced at the back end of the piston;
a cylindrical passage formed within the body adjacent the back end of the pistons to allow actuation of the piston to the extended position when hydraulic fluid is introduced into the cylindrical passage; and
a face plate connected to the inward facing surface of the piston, the face plate having an elliptical shape and an inward facing face with a curvature that corresponds generally to the external diameter of the centralizer end, wherein the face plate applies radial pressure to the outer surface of the centralizer when the piston is in the extended position to thereby crimp the centralizer to the tubular.

9. The crimping tool of claim 8, wherein the cylindrical passage formed adjacent a back end of the piston is in common communication with each of the pistons and is adapted for communication with an external hydraulic source.

10. The crimping tool of claim 7, wherein the pistons are disposed circumferentially around the central opening of the body.

11. The apparatus of claim 10, wherein an alignment element engages the inward facing face of each face plate to align the pistons with each other.

12. The crimping tool of claim 8, wherein the elliptical face plate is connected to the piston by a fastener that traverses a passage formed in the face plate and the piston.

13. The apparatus of claim 8, wherein an end of the centralizer is crimped to the tubular.

14. A method for securing a centralizer to a tubular comprising:
placing a centralizer around a tubular;
placing a crimping tool around an external diameter of the centralizer;
pressurizing a back end of a piston with hydraulic fluid to move the piston from a retracted position to an extended position to contact the external diameter of the centralizer with a face plate, wherein the face plate has an elliptical shape; and
applying pressure to the external diameter of the centralizer with the face plate to deform the centralizer onto the tubular and thereby secure the centralizer to the tubular.

15. The method of claim 14, wherein the piston is part of a plurality of pistons disposed circumferentially around the central opening of the body and pressurizing the pistons is via a cylindrical passage formed adjacent a back end of the piston to allow actuation of the piston to the extended position when hydraulic fluid is introduced into the passage.

16. The method of claim 14, wherein an alignment element engages the inward facing face of each face plate to align the pistons with each other and returns the pistons to the retracted position when hydraulic pressure is removed.

17. The method of claim 14, wherein the elliptical face plate is connected to the piston by a fastener that traverses a passage formed in the face plate and the piston.

18. The method of claim 14, wherein the inward facing face of the face plate has a curvature that corresponds generally to the external diameter of the centralizer end, wherein the face plate applies radial pressure to the outer surface of the centralizer end when the piston is in the extended position.

19. The method of claim 14, further comprising placing an end of the centralizer within the crimping tool.
